(19) United States
(12) Patent Application Publication
(10) Pub. No.: US 2024/0048832 A1
(43) Pub. Date: Feb. 8, 2024

(54) CAMERA MODULE AND CAMERA MODULE MANUFACTURING METHOD

(71) Applicant: Samsung Electro-Mechanics Co., Ltd., Suwon-si (KR)

(72) Inventor: Chul CHOI, Suwon-si (KR)

(73) Assignee: Samsung Electro-Mechanics Co., Ltd., Suwon-si (KR)

(21) Appl. No.: 18/178,600

(22) Filed: Mar. 6, 2023

(30) Foreign Application Priority Data
Aug. 8, 2022 (KR) 10-2022-0098874

(51) Int. Cl. H04N 23/55; G02B 7/02

(52) U.S. Cl. CPC H04N 23/55; G02B 7/021

(57) ABSTRACT

A camera module is provided. The camera module includes an image sensor, a lens assembly disposed on the image sensor and including a plurality of lenses, and an optical path member disposed between the image sensor and the lens assembly, wherein the optical path member is configured to be at least partially in contact with a first surface of a first lens adjacent to the image sensor among the plurality of lenses of the lens assembly.

### CROSS-REFERENCE TO RELATED APPLICATIONS

This application claims the benefit under 35 USC § 119(a) of Korean Patent Application No. 10-2022-0098874, filed on Aug. 8, 2022, in the Korean Intellectual Property Office, the entire disclosure of which is incorporated herein by reference for all purposes.

### BACKGROUND

### 1. Field

The following description relates to a camera module and a camera module manufacturing method.

### 2. Description of Related Art

With the development of information communication technology and semiconductor technology, the distribution and implementation of electronic devices is rapidly increasing. These electronic devices may provide various operations by convergence rather than staying in their traditional unique domains.

Cameras have been basically implemented in portable electronic devices such as, but not limited to, smartphones, tablet personal computers (PCs), and laptop computers, and operations such as, but not limited to, auto focus (AF) operations, Optical Image Stabilization (OIS) operations, and zoom operations have been added to cameras of portable electronic devices.

As an electronic device on which a camera module is mounted has been implemented with a thin form factor, the thickness of the camera module may become thinner, the size of an image sensor cannot be reduced based on a demand for high quality of images captured through the camera module, and accordingly, there is a demand for the camera module to have a small size and to not deteriorate the performance of the camera module.

The above information disclosed in this Background section is only for enhancement of understanding of the background of the described technology, and therefore, it may contain information that does not form the prior art that is already known in this country to a person of ordinary skill in the art.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

In a general aspect a camera module includes an image sensor; a lens assembly, disposed on the image sensor, and comprising a plurality of lenses; and an optical path member disposed between the image sensor and the lens assembly, wherein the optical path member is configured to be at least partially in contact with a first surface of a first lens adjacent to the image sensor among the plurality of lenses of the lens assembly.

The optical path member may be configured to be disposed directly on the image sensor.

A surface of the optical path member and the first surface of the first lens, which are at least partially in contact with each other, may be configured to have opposite shapes.

The optical path member may include a plurality of optical fibers.

The optical fibers may be configured to extend in parallel with a direction perpendicular to a surface of the image sensor.

The optical path member may include a plurality of optical waveguides.

The optical waveguides may be configured to extend in parallel with a direction perpendicular to a surface of the image sensor.

At least some of the plurality of lenses may be configured to move in a first direction parallel to a direction perpendicular to a surface of the image sensor.

The at least some of the lenses may be lenses other than the first lens of the plurality of lenses.

Lenses other than the first lens may be configured to move in a second direction substantially parallel to the surface of the image sensor.

The at least some of the lenses may include a second lens disposed farthest from the image sensor among the plurality of lenses.

The plurality of lenses may be configured to move in a second direction substantially parallel to the surface of the image sensor.

The second lens may be configured to move in a second direction substantially parallel to the surface of the image sensor.

In a general aspect, a camera module manufacturing method includes compressing, on a base body, a mold which has a first outer shape; removing the mold from the base body to form an optical path member which has a second outer shape opposite to the first outer shape of the mold; and positioning a first lens on the optical path member, wherein the optical path member is configured to be at least partially in contact with a first surface of the first lens.

The first lens may be configured to have a shape that is similar to the first outer shape of the mold.

The positioning of the first lens on the optical path member may include positioning the optical path member between the first lens and an image sensor.

The positioning of the first lens on the optical path member may include positioning a lens assembly comprising a plurality of lenses including the first lens on the optical path member.

The method may include attaching the base body to the image sensor prior to the compressing of the mold.

The positioning of the first lens on the optical path member may include positioning a lens assembly including a plurality of lenses including the first lens on the optical path member.

The base body may include a plurality of optical fibers or a plurality of fine optical waveguides.

Other features and aspects will be apparent from the following detailed description, the drawings, and the claims.

### BRIEF DESCRIPTION OF DRAWINGS

FIG. 1 illustrates a schematic cross-sectional view of an example camera module, in accordance with one or more embodiments.

FIG. 2 to FIG. 4 illustrate cross-sectional views showing some of a manufacturing method of an example camera module, in accordance with one or more embodiments.

FIG. 5 to FIG. 7 illustrate cross-sectional views showing some of a manufacturing method of an example camera module, in accordance with one or more embodiments.

FIG. 8 illustrates a schematic cross-sectional view of an example camera module, in accordance with one or more embodiments.

FIG. 9 illustrates a schematic cross-sectional view of an example camera module, in accordance with one or more embodiments.

FIG. 10 illustrates a schematic cross-sectional view of an example camera module, in accordance with one or more embodiments.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

Further, since sizes and thicknesses of constituent members shown in the accompanying drawings are arbitrarily given for better understanding and ease of description, the embodiments are not limited to the illustrated sizes and thicknesses. In the drawings, the thicknesses of layers, films, panels, regions, etc., are exaggerated for clarity. In the drawings, for better understanding and ease of description, the thicknesses of some layers and areas are exaggerated.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Further, throughout the specification, the phrase “in a plan view” means when an object portion is viewed from above, and the phrase “in a cross-sectional view” means when a cross-section taken by vertically cutting an object portion is viewed from the side.

Hereinafter, various embodiments and variations will be described in detail with reference to drawings.

One or more examples may provide a camera module that prevents that performance of the camera module from being deteriorated while a size of the camera module is thin.

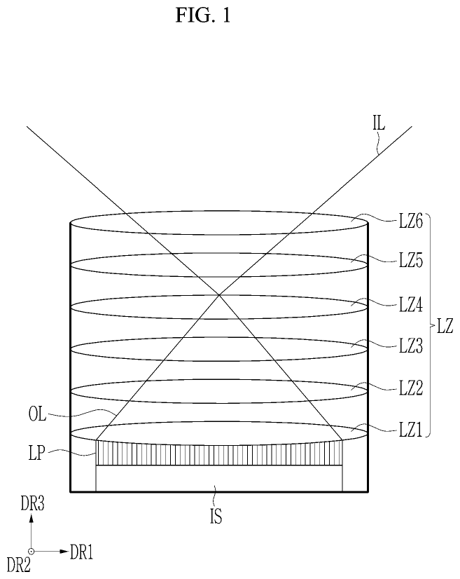

Hereinafter, a camera module, in accordance with one or more embodiments, will be described with reference to FIG. 1. FIG. 1 illustrates a schematic cross-sectional view of an example camera module, in accordance with one or more embodiments.

Referring to FIG. 1, the example antenna module may include an image sensor IS extending in a first direction DR1 and a second direction DR2, a lens assembly LZ configured to include a plurality of lenses LZ1, LZ2, LZ3, LZ4, LZ5, and LZ6 disposed in order away from the image sensor IS along a third direction DR3 perpendicular to the first direction DR1 and the second direction DR2, and an optical path member LP disposed between the lens assembly LZ and the image sensor IS.

According to the illustrated embodiment, the lenses LZ1, LZ2, LZ3, LZ4, LZ5, and LZ6 include 6 lenses of a first lens LZ1, a second lens LZ2, a third lens LZ3, a fourth lens LZ4, a fifth lens LZ5, and a sixth lens LZ6, but the embodiment is not limited thereto, and a number and size of the lenses are variable.

The first lens LZ1 and the optical path member LP of the lens assembly LZ disposed adjacent to each other in the third direction DR3 perpendicular to a surface of the image sensor IS may be disposed in close contact with each other. In an example, the optical path member LP may contact at least a portion of the first lens LZ1.

Accordingly, a surface of the first lens LZ1 and a surface of the optical path member LP of the lens assembly LZ disposed close to each other may have opposite shapes. For example, a surface of the optical path member LP corresponding to a convex portion of the first lens LZ1 along a direction parallel to the third direction DR3 may have a concave portion or shape, and a surface of the optical path member LP corresponding to a concave portion of the first lens LZ1 may have a convex portion or shape in a direction parallel to the third direction DR3.

The first lens LZ1 and the optical path member LP of the lens assembly LZ disposed adjacent to each other may be disposed in close contact with each other, so that most of the light passing through the lens assembly LZ may be incident toward the optical path member LP without leaking to the outside.

The optical path member LP may include a plurality of optical fibers extending in a direction parallel to the third direction DR3. Additionally, the optical path member LP may include a plurality of fine optical waveguides extending in the direction parallel to the third direction DR3.

Incident light IL, incident on the lens assembly LZ from the outside, may be refracted by the lenses LZ1, LZ2, LZ3, LZ4, LZ5, and LZ6, and refracted light OL may be incident toward the image sensor IS through the optical path member LP.

Typically, when a plane size of the image sensor IS is large, a distance between the lens assembly LZ and the image sensor IS increases along a direction parallel to the third direction DR3 in order for the refracted light OL refracted through the lens assembly LZ to be incident in a direction parallel to the third direction DR3 perpendicular to the surface of the image sensor IS, which requires a large number of lenses or increases a thickness of the lenses.

However, in accordance with the example camera module, the optical path member LP may include a plurality of optical fibers or a plurality of fine optical waveguides extending in a direction parallel to the third direction DR3, and is disposed between the lens assembly LZ and the image sensor IS and is closely disposed with the lens assembly LZ to be at least partially in contact with each other, and thus light passing through the lens assembly LZ may be incident on the image sensor IS in the direction parallel to the third direction DR3 that is perpendicular to the surface of the image sensor IS while passing through the optical path member LP.

Accordingly, the light passing through the lens assembly LZ may be incident on the image sensor IS in the direction parallel to the third direction DR3 that is perpendicular to the surface of the image sensor IS without increasing the distance between the lens assembly LZ and the image sensor IS along the direction parallel to the third direction DR3 or increasing the number of lenses of the lens assembly LZ.

Accordingly, in accordance with the example camera module, the thickness of the camera module may be reduced in the third direction DR3 without reducing the size of the image sensor IS.

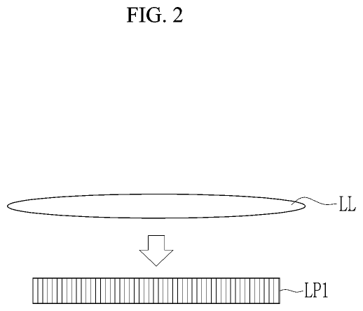

Hereinafter, a manufacturing method of a camera module, in accordance with one or more embodiments, will be described with reference to FIG. 2 to FIG. 4. FIG. 2 to FIG. 4 illustrate cross-sectional views showing some of a manufacturing method of a camera module, in accordance with one or more embodiments.

Referring to FIG. 2, a shape of a surface of a base body LP1 may be processed to have a shape that is opposite to a shape of a surface of the first lens LZ1 by pressing a mold LL having an external shape similar to the shape of the first lens LZ1 of the lens assembly LZ disposed in close contact with the optical path member LP on the base body LP1 constituting the optical path member LP. The base body LP1 may include a plurality of optical fibers or a plurality of fine optical waveguides.

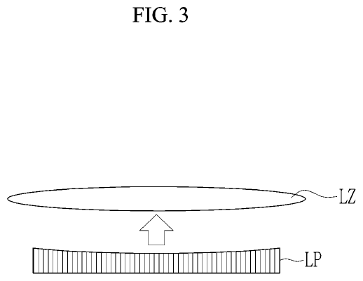

Referring to FIG. 3, the shape of the surface of the base body LP1 may be processed to have a shape opposite to a shape of the surface of the first lens LZ1, so that the optical path member LP is formed, and then the mold LL may be removed from the optical path member LP. The surface of the first lens LZ1 may be a first surface of the first lens LZ1 that is adjacent to the optical path member LP, and is disposed in close contact with the optical path member LP.

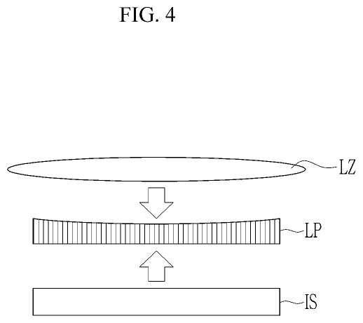

As illustrated in FIG. 4, the example camera module including the optical path member LP may be formed by assembling the optical path member LP of which the surface shape is processed as desired between the lens assembly LZ and the image sensor IS.

Accordingly, by processing the shape of the optical path member LP using the mold LL having a surface shape similar to a surface shape of the first lens LZ1, the optical path member LP and the first lens LZ1 of the lens assembly LZ disposed adjacent to each other along the third direction DR3 perpendicular to the surface of the image sensor IS may be disposed in close contact with each other to be at least partially touched, and a surface of the first lens LZ1 of the lens assembly LZ adjacent to each other and a surface of the optical path member LP may have opposite shapes.

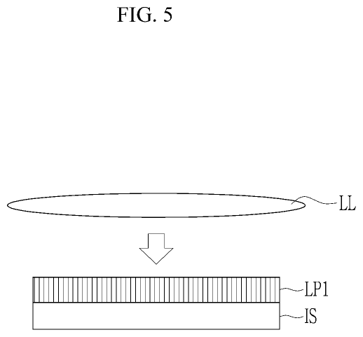

A method of manufacturing a camera module, in accordance with one or more embodiments, will be described with reference to FIG. 5 to FIG. 7. FIG. 5 to FIG. 7 illustrate cross-sectional views of some of a manufacturing method of a camera module, in accordance with one or more embodiments.

Referring to FIG. 5, the base body LP1, constituting the optical path member LP, may be attached on the image sensor IS, and then a shape of a surface of a base body LP1 may be processed to have a shape opposite to a shape of a surface of the first lens LZ1 by pressing a mold LL having an external shape similar to the shape of the surface of the first lens LZ1 of the lens assembly LZ disposed in close contact with the optical path member LP on the base body LP1 constituting the optical path member LP.

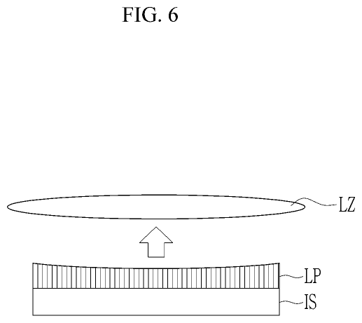

Referring to FIG. 6, the shape of the surface of the base body LP1 may be processed to have a shape opposite to a shape of the surface of the first lens LZ1, so that the optical path member LP is formed, and then the mold LL may be removed from the image sensor IS and the optical path member LP.

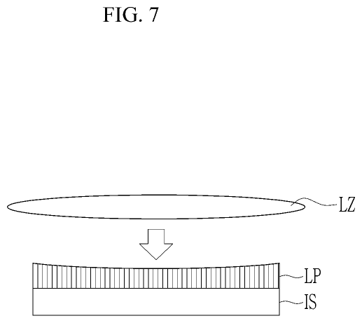

As illustrated in FIG. 7, the example camera module including the optical path member LP may be formed by assembling the lens assembly LZ on the optical path member LP of which the surface shape is processed as desired, to be in close contact with lens LZ1 of the lens assembly LZ.

Accordingly, by processing the shape of the optical path member LP using the mold LL having a surface shape that is similar to a surface shape of the first lens LZ1, the optical path member LP and the first lens LZ1 of the lens assembly LZ disposed adjacent to each other along the third direction DR3 perpendicular to the surface of the image sensor IS, may be disposed in close contact with each other to be at least partially touched, and a surface of the first lens LZ1 of the lens assembly LZ adjacent to each other and a surface of the optical path member LP may have opposite shapes.

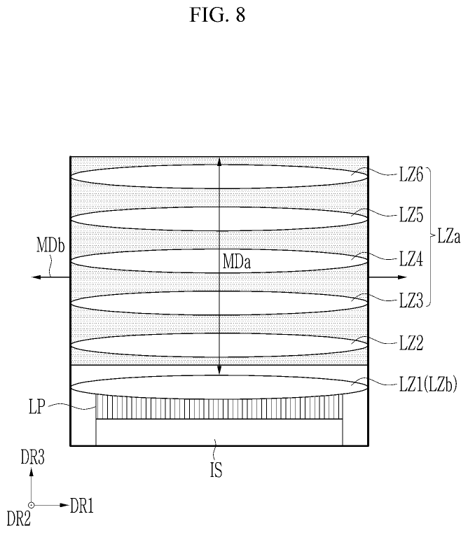

Hereinafter, a camera module, in accordance with one or more embodiments, will be described with reference to FIG. 8. FIG. 8 illustrates a schematic cross-sectional view of a camera module, in accordance with one or more embodiments.

Referring to FIG. 8, the example camera module is similar to the example camera module according to the embodiment described with reference to FIG. 1.

The example antenna module may include an image sensor IS extending in a first direction DR1 and a second direction DR2, a lens assembly LZ configured to include a plurality of lenses LZ1, LZ2, LZ3, LZ4, LZ5, and LZ6 disposed in order away from the image sensor IS along a third direction DR3 perpendicular to the first direction DR1 and the second direction DR2, and an optical path member LP disposed between the lens assembly LZ and the image sensor IS.

The optical path member LP and the first lens LZ1 of the lens assembly LZ disposed adjacent to each other along the third direction DR3 perpendicular to the surface of the image sensor IS, may be disposed in close contact with each other to be at least partially touched, and a surface of the first lens LZ1 of the lens assembly LZ and a surface of the optical path member LP may have opposite shapes in an adjacent portion.

The optical path member LP may include a plurality of optical fibers extending in a direction parallel to the third direction DR3. Additionally, the optical path member LP may include a plurality of fine optical waveguides extending in the direction parallel to the third direction DR3.

Referring to FIG. 8, among the lenses LZ1, LZ2, LZ3, LZ4, LZ5, and LZ6 of the lens assembly LZ, the lenses LZ2, LZ3, LZ4, LZ5, and LZ6 except for the first lens LZ1 adjacent to the optical path member LP may move along the third direction DR3 that is perpendicular to the surface of the image sensor IS and a fifth direction MDa that is parallel thereto, and may focus the lens assembly LZ by moving along the fifth direction MDa.

Additionally, among the lenses LZ1, LZ2, LZ3, LZ4, LZ5, and LZ6 of the lens assembly LZ, the lenses LZ2, LZ3, LZ4, LZ5, and LZ6 except for the first lens LZ1 adjacent to the optical path member LP may move along a sixth direction MDb parallel to a first direction DR1 or the second direction DR2 in which the surface of the image sensor IS is extended, and may compensate for hand shake of the lens assembly LZ by moving along the sixth direction MDb.

Accordingly, in accordance with the example camera module, among the lenses LZ1, LZ2, LZ3, LZ4, LZ5, and LZ6 of the lens assembly LZ, the lenses LZ2, LZ3, LZ4, LZ5, and LZ6 except for the first lens LZ1 adjacent to the optical path member LP may perform an autofocus (AF) operation and an optical image stabilization (OIS) operation by moving in a direction parallel to the fifth direction MDa and the sixth direction MDb.

Many features of the display device according to the embodiment described above with reference to FIG. 1 to FIG. 7 may be applied to the display device according to the present embodiment.

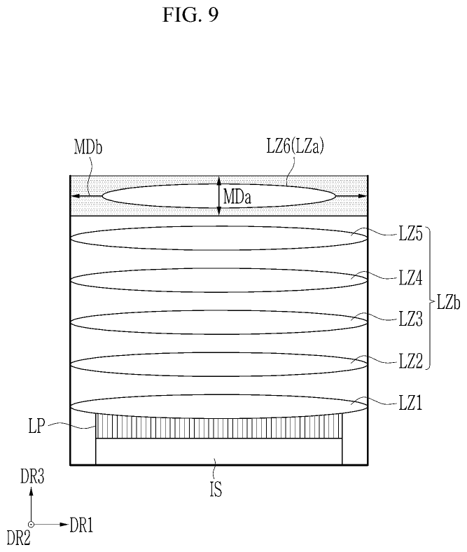

Hereinafter, a camera module, in accordance with one or more embodiments, will be described with reference to FIG. 9. FIG. 9 illustrates a schematic cross-sectional view of a camera module, in accordance with one or more embodiments.

Referring to FIG. 9, the display device, in accordance with the example embodiment, is similar to the display device according to the embodiment previously described with reference to FIG. 1 and FIG. 8.

The example antenna module may include an image sensor IS extending in a first direction DR1 and a second direction DR2, a lens assembly LZ configured to include a plurality of lenses LZ1, LZ2, LZ3, LZ4, LZ5, and LZ6 disposed in order away from the image sensor IS along a third direction DR3 perpendicular to the first direction DR1 and the second direction DR2, and an optical path member LP disposed between the lens assembly LZ and the image sensor IS.

The optical path member LP and the first lens LZ1 of the lens assembly LZ disposed adjacent to each other along the third direction DR3 perpendicular to the surface of the image sensor IS, may be disposed in close contact with each other to be at least partially touched, and a surface of the first lens LZ1 of the lens assembly LZ and a surface of the optical path member LP may have opposite shapes in an adjacent portion.

The optical path member LP may include a plurality of optical fibers extending in a direction parallel to the third direction DR3. Additionally, the optical path member LP may include a plurality of fine optical waveguides extending in the direction parallel to the third direction DR3.

Referring to FIG. 9, among the lenses LZ1, LZ2, LZ3, LZ4, LZ5, and LZ6 of the lens assembly LZ, the sixth lens LZ6 farthest from the optical path member LP may move along the third direction DR3 that is perpendicular to the surface of the image sensor IS and a fifth direction MDa that is parallel thereto, and may focus the lens assembly LZ by moving along the fifth direction MDa.

Additionally, among the lenses LZ1, LZ2, LZ3, LZ4, LZ5, and LZ6 of the lens assembly LZ, the sixth lens LZ6 farthest from the optical path member LP may move along a sixth direction MDb parallel to a first direction DR1 or the second direction DR2 in which the surface of the image sensor IS, is extended, and may compensate for hand shake of the lens assembly LZ by moving along the sixth direction MDb.

Accordingly, in accordance with the example camera module, among the lenses LZ1, LZ2, LZ3, LZ4, LZ5, and LZ6 of the lens assembly LZ, the sixth lens LZ6 farthest from the optical path member LP may perform an autofocus (AF) operatipon and an optical image stabilization (OIS) operation by moving in a direction parallel to the fifth direction MDa and the sixth direction MDb.

However, the examples are not limited thereto, and the autofocus (AF) operation and the optical image stabilization (OIS) operation may be performed by moving any one of the lenses LZ1, LZ2, LZ3, LZ4, LZ5, and LZ6.

Many features of the display device according to the example described above with reference to FIG. 1 to FIG. 9 may be applied to the display device according to the present example.

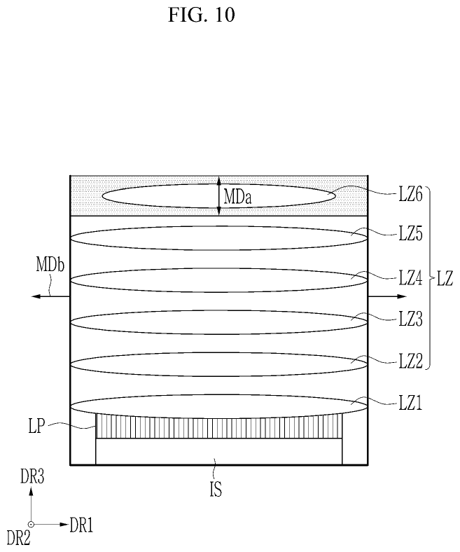

Hereinafter, a camera module, in accordance with one or more embodiments, will be described with reference to FIG. 10. FIG. 10 illustrates a schematic cross-sectional view of a camera module in accordance with one or more embodiments.

Referring to FIG. 10, the display device according to the present embodiment is similar to the display device according to the embodiment previously described with reference to FIG. 1 and FIG. 8.

The example antenna module may include an image sensor IS extending in a first direction DR1 and a second direction DR2, a lens assembly LZ configured to include a plurality of lenses LZ1, LZ2, LZ3, LZ4, LZ5, and LZ6 disposed in order away from the image sensor IS along a third direction DR3 perpendicular to the first direction DR1 and the second direction DR2, and an optical path member LP disposed between the lens assembly LZ and the image sensor IS.

The optical path member LP and the first lens LZ1 of the lens assembly LZ disposed adjacent to each other along the third direction DR3 perpendicular to the surface of the image sensor IS, may be disposed in close contact with each other to be at least partially touched, and a surface of the first lens LZ1 of the lens assembly LZ and a surface of the optical path member LP may have opposite shapes in an adjacent portion.

The optical path member LP may include a plurality of optical fibers extending in a direction parallel to the third direction DR3. Additionally, the optical path member LP may include a plurality of fine optical waveguides extending in the direction parallel to the third direction DR3.

Referring to FIG. 10, among the lenses LZ1, LZ2, LZ3, LZ4, LZ5, and LZ6 of the lens assembly LZ, the sixth lens LZ6 farthest from the optical path member LP may move along the third direction DR3 that is perpendicular to the surface of the image sensor IS and a fifth direction MDa that is parallel thereto, and may focus the lens assembly LZ by moving along the fifth direction MDa.

Additionally, the lenses LZ1, LZ2, LZ3, LZ4, LZ5, and LZ6 of the lens assembly LZ may move along a sixth direction MDb parallel to a first direction DR1, or the second direction DR2 in which the surface of the image sensor IS, is extended, and may compensate for hand shake of the lens assembly LZ by moving along the sixth direction MDb.

Accordingly, in accordance with the example camera module, among the lenses LZ1, LZ2, LZ3, LZ4, LZ5, and LZ6 of the lens assembly LZ, the sixth lens LZ6 farthest from the optical path member LP may perform an autofocus (AF) operation, and the lenses LZ1, LZ2, LZ3, LZ4, LZ5, and LZ6 of the lens assembly LZ may perform an optical image stabilization (OIS) operation.

Many features of the display device according to the example described above with reference to FIG. 1 to FIG. 9 may be applied to the display device according to the present example.

As described above, according to the example camera modules, the optical path member LP may include a plurality of optical fibers or a plurality of fine optical waveguides extending in a direction parallel to the third direction DR3, and may be disposed between the lens assembly LZ and the image sensor IS, and may be closely disposed with the lens assembly LZ to be at least partially in contact with each other, and thus light passing through the lens assembly LZ may be incident on the image sensor IS in the direction parallel to the third direction DR3 that is perpendicular to the surface of the image sensor IS while passing through the optical path member LP. Accordingly, the light passing through the lens assembly LZ may be incident on the image sensor IS in the direction parallel to the third direction DR3 that is perpendicular to the surface of the image sensor IS without increasing the distance between the lens assembly LZ and the image sensor IS along the direction parallel to the third direction DR3 or increasing the number of lenses of the lens assembly LZ.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
an image sensor;
a lens assembly, disposed on the image sensor, and comprising a plurality of lenses; and
an optical path member disposed between the image sensor and the lens assembly,
wherein the optical path member is configured to be at least partially in contact with a first surface of a first lens adjacent to the image sensor among the plurality of lenses of the lens assembly.

2. The camera module of claim 1, wherein the optical path member is configured to be disposed directly on the image sensor.

3. The camera module of claim 1, wherein:
a surface of the optical path member and the first surface of the first lens, which are at least partially in contact with each other, are configured to have opposite shapes.

4. The camera module of claim 1, wherein the optical path member comprises a plurality of optical fibers.

5. The camera module of claim 4, wherein the optical fibers are configured to extend in parallel with a direction perpendicular to a surface of the image sensor.

6. The camera module of claim 1, wherein the optical path member comprises a plurality of optical waveguides.

7. The camera module of claim 6, wherein the optical waveguides are configured to extend in parallel with a direction perpendicular to a surface of the image sensor.

8. The camera module of claim 1, wherein:
at least some of the plurality of lenses are configured to move in a first direction parallel to a direction perpendicular to a surface of the image sensor.

9. The camera module of claim 8, wherein the at least some of the lenses are lenses other than the first lens of the plurality of lenses.

10. The camera module of claim 9, wherein:
lenses other than the first lens are configured to move in a second direction substantially parallel to the surface of the image sensor.

11. The camera module of claim 8, wherein the at least some of the lenses comprise a second lens disposed farthest from the image sensor among the plurality of lenses.

12. The camera module of claim 11, wherein:
the plurality of lenses are configured to move in a second direction substantially parallel to the surface of the image sensor.

13. The camera module of claim 11, wherein:
the second lens is configured to move in a second direction substantially parallel to the surface of the image sensor.

14. A camera module manufacturing method, comprising:
compressing, on a base body, a mold which has a first outer shape;
removing the mold from the base body to form an optical path member which has a second outer shape opposite to the first outer shape of the mold; and
positioning a first lens on the optical path member,
wherein the optical path member is configured to be at least partially in contact with a first surface of the first lens.

15. The manufacturing method of claim 14, wherein the first lens is configured to have a shape that is similar to the first outer shape of the mold.

16. The manufacturing method of claim 15, wherein:
the positioning of the first lens on the optical path member comprises positioning the optical path member between the first lens and an image sensor.

17. The manufacturing method of claim 16, wherein:
the positioning of the first lens on the optical path member comprises positioning a lens assembly comprising a plurality of lenses including the first lens on the optical path member.

18. The manufacturing method of claim 15, further comprising attaching the base body to the image sensor prior to the compressing of the mold.

19. The manufacturing method of claim 18, wherein:
the positioning of the first lens on the optical path member comprises positioning a lens assembly including a plurality of lenses including the first lens on the optical path member.

20. The manufacturing method of claim 14, wherein:
the base body comprises a plurality of optical fibers or a plurality of fine optical waveguides.
